(19) United States
(12) Patent Application Publication
(10) Pub. No.: US 2022/0108662 A1
(43) Pub. Date: Apr. 7, 2022

(54) DISPLAY MODES

(71) Applicant: Hewlett-Packard Development Company, L.P., Spring, TX (US)

(72) Inventors: Hsing-Hung Hsieh, Taipei City (TW); Thong Thai, Spring, TX (US); Ann Alejandro Villegas, Spring, TX (US)

(73) Assignee: Hewlett-Packard Development Company, L.P., Spring, TX (US)

(21) Appl. No.: 17/418,804

(22) PCT Filed: Jun. 3, 2019
(86) PCT No.: PCT/US2019/035170

§ 371 Date: Jun. 26, 2021

(51) Int. Cl. G09G 3/34; G02F 1/13357

(52) U.S. Cl. CPC G09G 3/3413; G02F 1/133603; G09G 2330/021; G09G 2320/062; G09G 2320/0626

(57) ABSTRACT

An example device for providing display modes can include a display that includes a plurality of light sources and a collimated backlight, a driver coupled to a switch that is coupled to the plurality of light sources with a first electrical connection for a first mode and a second electrical connection for a second mode, wherein the first electrical connection provides a first amperage to the plurality of light sources and the second electrical connection provides a second amperage to the plurality of light sources, and a computing device comprising instructions executable by a processing resource to: initiate the first mode by providing an instruction to the switch to activate the first electrical connection, and initiate the second mode by providing an instruction to the switch to activate the second electrical connection.

### BACKGROUND

A display or monitor can include an output device that can display information in a pictorial form. The display can include a plurality of light sources that can be utilized to generate images that are displayed utilizing different combinations of the plurality of light sources. The display can be coupled to a computing device to receive images from the computing device to generate the received images utilizing the plurality of light sources.

### BRIEF DESCRIPTION OF THE DRAWINGS

FIG. 1 is an example system for providing display modes consistent with the present disclosure.

FIG. 2 is an example computer-readable storage medium for providing display modes consistent with the present disclosure.

FIG. 3 is an example system for providing display modes consistent with the present disclosure.

FIG. 4 is an example display for providing display modes consistent with the present disclosure.

FIG. 5 is an example of different collimated backlights for providing display modes consistent with the present disclosure.

### DETAILED DESCRIPTION

Displays can be devices to display digital images. In some examples, a display can be a computing display, a laptop display, a phone display, and/or a television display. Displays can be utilized to perform a plurality of different functions. For example, displays can be coupled to computing devices to allow a user to make selections and interact with the computing device. In some examples, the selections or interactions through a display can include sensitive information that a user may want to restrict from other individuals within an area. In these examples, a privacy display can be utilized to prevent individuals around the display from viewing the images displayed on the display.

In some examples, a privacy display can utilize filters that can scatter the light generated by the plurality of light sources near the edges of the display to generate what appears to be a white background to a user positioned at a particular angle from the display (e.g., an angle that is greater than a threshold angle, etc.). These examples of a privacy display can be considered white background privacy displays. The white background privacy displays can utilize a relatively higher quantity of electrical energy to generate the white background portion of the privacy display.

In some examples, a privacy display can utilize a collimated backlight that utilizes light sources that are angled toward a center of the display. In this way, a brightness level of the plurality of light sources can be altered such that a user positioned across from a center of the display can view the images displayed and a user positioned near the edges of the display views a dark or black background instead of the images displayed. In this way, a user of the display can prevent other individuals from viewing what the user considers private information. These privacy displays can be considered black background privacy displays. The black background privacy displays can be limited to relatively bright display settings, which can be difficult to utilize in low light environments.

The present disclosure relates to systems and devices for providing a privacy display that utilizes a collimated backlight and multiple modes to allow for a black background privacy display that can utilize lower brightness display settings compared to previous privacy displays. In this way, a black background privacy display can be utilized in low light environments and utilize relatively less electrical energy compared to previous privacy displays. For example, the privacy displays described herein can include a driver coupled to a switch that is coupled to a plurality of light sources with a first electrical connection for a first mode and a second electrical connection for a second mode. In this example, the first electrical connection can provide a first amperage to the plurality of light sources and the second electrical connection can provide a second amperage to the plurality of light sources. By providing different amperages to the plurality of light sources based on a mode (e.g., privacy mode, sharing mode, etc.), the privacy displays described herein can provide a privacy mode that can be utilized in low light environments while utilizing less electrical energy.

FIG. 1 is an example system 100 for providing display modes consistent with the present disclosure. In some examples, the system 100 can include a display 114 coupled to a computing device 102 through a connection 112. In some examples, the connection 112 can allow the computing device 102 to communicate with the display 114. For example, the computing device 102 can generate digital images that can be displayed by the display 114 utilizing light sources 124.

As described further herein, the light sources 124 can include a collimated backlight that can direct the light sources 124 toward a center portion of the display 114 such that when a brightness level of the light sources 124 falls below a threshold brightness a privacy mode is initiated that prevents images displayed by the light sources 124 to be viewed from edges of the display 114. For example, the display 114 can provide a visual area 126 within a particular range of angles and provide a private area 128-1, 128-2 that exceeds the particular range of angles. In this example, the visual area 126 can include an area where images displayed on the display 114 are visible to a user and the private area 128-1, 128-2 can include an area where images displayed on the display are not visible to the user. In some examples, the private area 128-1, 128-2 can appear white when the display 114 is a white background privacy display and the private area 128-1, 128-2 can appear black or dark when the display 114 is a black background privacy display.

In some examples, the system 100 can include a computing device 102 that is communicatively coupled to the display 114 through connection 112. The computing device 102 can include a processing resource 104 communicatively coupled to a memory resource 106 storing instructions 108, 110 to perform particular functions associated with providing display modes for the display 114. In some examples, the computing device 102 can be utilized to initiate a first mode or sharing mode and to initiate a second mode or private mode.

In some examples, the computing device 102 can initiate the first mode by altering a switch 118 to a first electrical connection 120-1 and the computing device 102 can initiate the second mode by altering the switch to a second electrical connection 120-2 that includes a resistor 122. In some examples, first mode includes a brightness that is above a threshold brightness and the second mode includes a brightness that is below the threshold brightness. In some examples, the first mode is adjustable to a brightness level that exceeds 1000 nits and the second mode is adjustable to a brightness level that is below 10 nits. In this way, the brightness of the first mode can be relatively brighter than previous systems and the second mode can be relatively dimmer than the previous systems.

In some examples, the display 114 can include a driver 116 coupled to a switch 118 to provide a particular level of electrical power to the light sources 124 through one of a first electrical connection 120-1 and a second electrical connection 120-2. For example, the system 100 can include a driver 116 coupled to a switch 118 that is coupled to the plurality of light sources 124 with a first electrical connection 120-1 for a first mode and a second electrical connection 120-2 for a second mode. In this example, the first electrical connection 120-1 provides a first amperage to the plurality of light sources 124 and the second electrical connection 120-2 provides a second amperage to the plurality of light sources 124.

In some examples, the resistor 122 can alter the amperage provided by the driver 116. For example, the second electrical connection can include a resistor device (e.g., resistor 122, etc.) to alter the maximum amperage from a first maximum amperage (e.g., 20 milliamps) to a second maximum amperage (e.g., 8 milliamps). In some examples, the first amperage includes a maximum amperage of 20 milliamps and the second amperage includes a maximum amperage of 8 milliamps. In some examples, the first amperage can be a first maximum amperage and the second amperage can be a second maximum amperage that is a percentage of the first maximum amperage.

Processing resource 104, as used herein, can include a number of processing resources capable of executing instructions stored by a memory resource 106. The instructions 108, 110, (e.g., machine-readable instructions (MRI)) can include instructions stored on the memory resource 106 and executable by the processing resource 104 to implement a desired function (e.g., initiate a sharing mode, initiate a private mode, etc.). The memory resource 106, as used herein, can include a number of memory components capable of storing non-transitory instructions that can be executed by processing resource 104.

The memory resource 106 can be in communication with the processing resource 104 via a communication link (e.g., path). The communication link can be local or remote to an electronic device associated with the processing resource 104. The memory resource 106 includes instructions 108, 110. The memory resource 106 can include more or fewer instructions than illustrated to perform the various functions described herein. In some examples, instructions (e.g., software, firmware, etc.) 108, 110 can be downloaded and stored in memory resource 106 (e.g., MRM) as well as a hard-wired program (e.g., logic), among other possibilities.

Instructions 108, when executed by a processing resource such as processing resource 104 can initiate a first mode by providing an instruction to the switch 118 to activate the first electrical connection 120-1. In some examples, the switch 118 can be communicatively controlled by the computing device 102 through connection 112. In some examples, the connection 112 can be a physical connection and/or a wireless connection. In some examples, the instructions 108 can alter the switch 118 to complete the first electrical connection 120-1 between the driver 116 and the light sources 124.

As described herein, the first electrical connection 120-1 can include a first light source maximum current for the light sources 124. As used herein, a light source maximum current can be a current provided to the light sources 124 by the driver 116 when a maximum brightness is selected for the display 114. In some examples, the first light source maximum current for the light sources 124 can be within a range of 15 milliamps to 30 milliamps. In some examples, the light source maximum current can correspond to a particular pulse width modulation (PWM) duty cycle and/or a resulted brightness range of the light sources 124.

In a specific example, the first electrical connection 120-1 can allow the driver 116 to provide a light source maximum current of 20 milliamps with a PWM duty cycle range of 11 percent to 100 percent to provide a resulted brightness range for the light sources 124 between 150 nits and 1300 nits. In these examples, the first electrical connection 120-1 can be activated to activate a sharing mode of the display 114. As used herein, the sharing mode (e.g., first mode, etc.) can be a mode that allows a user or other individuals to view images on the display 114 from the visual area 126 and/or the private areas 128-1, 128-2. Thus, the sharing mode or first mode provided by the first electrical connection can alter the private areas 128-1, 128-2 to visual areas.

Instructions 110, when executed by a processing resource such as processing resource 104 can initiate a second mode by providing an instruction to the switch 118 to activate the second electrical connection 120-2. As described herein, the switch 118 can be communicatively controlled by the computing device 102 through connection 112. In some examples, the instructions 110 can alter the switch 118 to complete the second electrical connection 120-2 between the driver 116 and the light sources 124.

As described herein, the second electrical connection 120-2 can include a second light source maximum current for the light sources 124. In some examples, the second light source maximum current for the light sources 124 can be less than the first light source maximum current provided by the first electrical connection 120-1. In some examples, the second light source maximum current for the light sources 124 can be within a range of 5 milliamps to 10 milliamps when the first light source maximum current for the light sources 124 is between 15 milliamps to 30 milliamps. As described herein, the light source maximum current can correspond to a particular pulse width modulation (PWM) duty cycle and/or a resulted brightness range of the light sources 124.

In a specific example, the second electrical connection 120-2 can allow the driver 116 to provide a light source maximum current of 8 milliamps with a PWM duty cycle range of 1 percent to 30 percent to provide a resulted brightness range for the light sources 124 between 5 nits and 150 nits. In these examples, the second electrical connection 120-1 can be activated to activate a private mode of the display 114. As used herein, the private mode (e.g., second mode, etc.) can be a mode that prevents a user or other individuals from viewing images on the display 114 within the private areas 128-1, 128-2 while allowing a user or other individual to view images on the display 114 within the visual area 126. Thus, the private mode or second mode provided by the second electrical connection 120-2 can provide the private areas 128-1, 128-2 to restrict an area for viewing images on the display 114 to the visual area 126.

In some examples, utilizing a first electrical connection 120-1 with a first resistance that can allow the driver 116 to provide a first light source maximum current to the light sources 124 during a first mode and utilizing a second electrical connection 120-2 with a second resistance or added resistor 122 to provide a second light source maximum current to the light sources 124 during a second mode can allow relatively lower resulted brightness during the second mode compared to previous systems and methods that utilized a single electrical connection.

The system 100 can provide a relatively higher PWM duty cycle and a relatively lower minimum resulted brightness during the second mode by utilizing the second electrical connection 120-2 compared to utilizing the first electrical connection 120-1. For example, the system 100 may be limited to providing a maximum PWM duty cycle of 12 percent when utilizing the first electrical connection 120-1 for a private mode while the system 100 may be capable of providing a maximum PWM duty cycle of 30 percent when utilizing the second electrical connection 120-2 for a private mode. In this way, the system 100 can provide a better image quality and brightness ranges for a private mode compared to systems that utilize the same electrical connection to provide a sharing mode and a private mode.

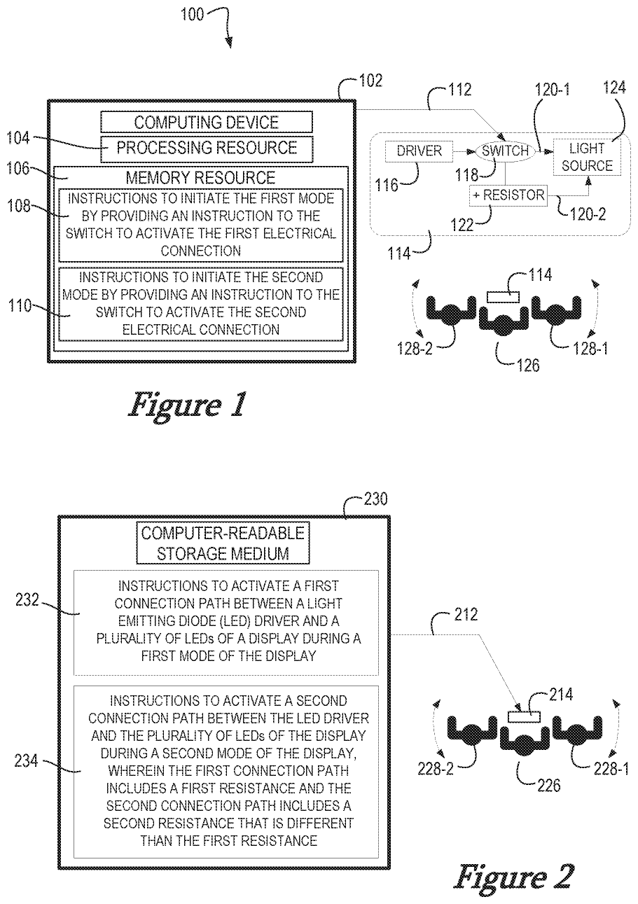

FIG. 2 is an example computer-readable storage medium 230 for providing display modes consistent with the present disclosure. In some examples, the computer-readable storage medium 230 can be a memory resource (e.g., memory resource 106 as referenced in FIG. 1, etc.) as described herein. In some examples, the computer-readable storage medium 230 can be communicatively coupled to a computing device (e.g., computing device 100 as referenced in FIG. 1, etc.) and/or other type of physical device that can be utilized to provide display modes for a display 214.

The computer-readable storage medium 230 can be in communication with a processing resource (e.g., processing resource 104 as referenced in FIG. 1, etc.) via a communication link (e.g., path). The communication link can be local or remote to an electronic device associated with the processing resource. The computer-readable storage medium 230 includes instructions 232, 234. The computer-readable storage medium 230 can include more or fewer instructions than illustrated to perform the various functions described herein. In some examples, instructions (e.g., software, firmware, etc.) 232, 234 can be downloaded and stored in computer-readable storage medium 230 (e.g., memory resource, etc.) as well as a hard-wired program (e.g., logic), among other possibilities.

Instructions 232, when executed by a processing resource, can activate a first connection path between a light emitting diode (LED) driver and a plurality of LEDs of a display 214 during a first mode of the display. In some examples, the first connection path can be a first electrical connection with a first resistance. In some examples, the first connection path can be activated utilizing a switch (e.g., switch 118 as referenced in FIG. 1, etc.) to complete a connection between a LED driver and a plurality of LEDs of the display 214 with the first connection. In some examples, the computer-readable storage medium 230 can be communicatively coupled to the display 214 through a connection 212. In some examples, the connection 212 can be utilized to alter a state of a switch to alter the connection path between the LED driver and the plurality of LEDs.

As described herein, the first connection path can be a first electrical connection that allows the LED driver to provide particular connection features to the plurality of LEDs of the display 214. For example, the first connection path can allow the LED driver to provide a first amperage, a first PWM duty cycle, and/or resulting brightness level of the plurality of LEDs of the display 214. In some examples, the first connection path can be utilized to provide a first mode, such as a sharing mode where images displayed on the display 214 are viewable from a visual area 126 and from private areas 228-1, 228-2. That is, the visual area 126 can be utilized to view images on the display 214 and private areas 228-1, 228-2 can also be utilized to view images on the display 214 during a sharing mode or first mode of the display 214.

Instructions 234, when executed by a processing resource, can activate a second connection path between the LED driver and the plurality of LEDs of the display 214 during a second mode of the display 214. As described herein, activating the second connection path can include altering a state of a switch to complete the second connection path between the LED driver and the plurality of LEDs of the display 214. In some examples, the switch can disconnect the first connection path when completing the second connection path. In a similar way, the switch can disconnect the second connection path when completing the first connection path.

In some examples, the first connection path includes a first resistance and the second connection path includes a second resistance that is different than the first resistance. In some examples, the first connection path and the second connection path can utilize different levels of resistance to allow the LED driver to provide different electrical properties to the plurality of LEDs of the display 214. For example, the first connection path can be utilized to allow the LED driver to provide a first amperage, a first PWM duty cycle, and/or first resulting brightness level of the plurality of LEDs of the display 214 while the second connection path can be utilized to allow the LED driver to provide a second amperage, a second PWM duty cycle, and/or a second resulting brightness level of the plurality of LEDs of the display 214.

In some examples, the second connection path can be utilized to provide a second mode, such as a private mode where images displayed on the display 214 are viewable from a visual area 126 and are not viewable from private areas 228-1, 228-2. That is, the visual area 126 can be utilized to view images on the display 214 and the private areas 228-1, 228-2 can appear dark or black to prevent a user from viewing the images on the display 214.

In some examples, the second connection path can include a greater resistance than the first connection path such that a resulting brightness of the plurality of LEDs of the display 214 are limited to a threshold brightness such that the private areas 228-1, 228-2 appear dark or black to prevent the user from viewing images on the display 214. In this way, the second connection path can be initiated to initiate a privacy mode and the first connection path can be initiated to initiate a sharing mode. By utilizing a designated connection path for a sharing mode and a designated connection path for a private mode, the quality of the sharing mode and private mode can be greater than utilizing a single connection path for both the sharing mode and the private mode.

In some examples, the first connection path is activated in response to a first selection and the second connection path is activated in response to a second selection. In some examples, the first selection can be a selection to put the display 214 into a sharing mode and the second selection can be a selection to put the display 214 into a private mode. In other examples, the first connection path is activated in response to a selection of a brightness level that exceeds a brightness level threshold and the second connection path is activated in response to a selection of a brightness level that is below the brightness level threshold.

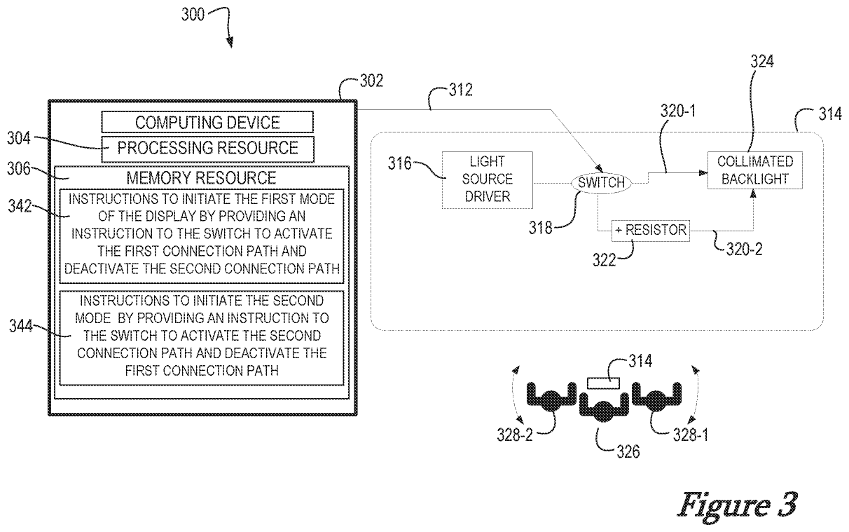

FIG. 3 is an example system 300 for providing display modes consistent with the present disclosure. In some examples, the system 300 can include a display 314 coupled to a computing device 302 through a connection 312. In some examples, the connection 312 can allow the computing device 302 to communicate with the display 314. For example, the computing device 302 can generate digital images that can be displayed by the display 314 utilizing a collimated backlight 346. As used herein, a collimated backlight 346 includes light sources that utilize parallel rays or substantially parallel rays that spread minimally as the rays propagate.

As described further herein, the collimated backlight 346 can direct the light sources toward a center portion of the display 314 such that when a brightness level of the light sources falls below a threshold brightness a privacy mode is initiated that prevents images displayed by the light sources to be viewed from edges of the display 314 (e.g., private area 328-1, 328-2, etc.). For example, the display 314 can provide a visual area 326 within a particular range of angles and provide a private area 328-1, 328-2 that exceeds the particular range of angles. In this example, the visual area 326 can include an area where images displayed on the display 314 are visible to a user and the private area 328-1, 328-2 can include an area where images displayed on the display are not visible to the user.

In some examples, the system 300 can include a computing device 302 that is communicatively coupled to the display 314 through connection 312. The computing device 302 can include a processing resource 304 communicatively coupled to a memory resource 306 storing instructions 342, 344 to perform particular functions associated with providing display modes for the display 314. In some examples, the computing device 302 can be utilized to initiate a first mode or sharing mode and to initiate a second mode or private mode. In some examples, the computing device 302 can initiate the first mode by altering a switch 318 to a first electrical connection 320-1 and the computing device 302 can initiate the second mode by altering the switch 318 to a second electrical connection 320-2 that includes a resistor 322.

Instructions 342, when executed by a processing resource such as processing resource 304 can initiate a first mode of the display 314 by providing an instruction to the switch 318 to activate the first connection path 320-1 and deactivate the second connection path 320-2. In some examples, the switch 318 can be communicatively controlled by the computing device 302 through connection 312. In some examples, the connection 312 can be a physical connection and/or a wireless connection. In some examples, the instructions 342 can alter the switch 318 to complete the first electrical connection 320-1 between the light source driver 316 and the collimated backlight 346.

As described herein, the first electrical connection 320-1 can include a first light source maximum current for the light sources of the collimated backlight 346. As used herein, a light source maximum current can be a current provided to the light sources of the collimated backlight 346 by the driver 316 when a maximum brightness is selected for the display 314. In some examples, the first light source maximum current for the light sources of the collimated backlight 346 can be within a range of 15 milliamps to 30 milliamps. In some examples, the light source maximum current can correspond to a particular pulse width modulation (PWM) duty cycle and/or a resulted brightness range of the light sources of the collimated backlight 346.

In a specific example, the first electrical connection 320-1 can allow the driver 316 to provide a light source maximum current of 20 milliamps with a PWM duty cycle range of 11 percent to 100 percent to provide a resulted brightness range for the light sources of the collimated backlight 346 between 150 nits and 1300 nits. In these examples, the first electrical connection 320-1 can be activated to activate a sharing mode of the display 314. As used herein, the sharing mode (e.g., first mode, etc.) can be a mode that allows a user or other individuals to view images on the display 314 from the visual area 326 and/or the private areas 328-1, 328-2. Thus, the sharing mode or first mode provided by the first electrical connection 320-1 can alter the private areas 328-1, 328-2 to visual areas.

Instructions 344, when executed by a processing resource such as processing resource 304 can initiate the second mode by providing an instruction to the switch 318 to activate the second connection path 320-2 and deactivate the first connection path 320-1. As described herein, the switch 318 can be communicatively controlled by the computing device 302 through connection 312. In some examples, the instructions 344 can alter the switch 318 to complete the second electrical connection 320-2 between the driver 316 and the light sources of the collimated backlight 346.

As described herein, the second electrical connection 320-2 can include a second light source maximum current for the light sources of the collimated backlight 346. In some examples, the second light source maximum current for the light sources of the collimated backlight 346 can be less than the first light source maximum current provided by the first electrical connection 320-1. In some examples, the second light source maximum current for the light sources of the collimated backlight 346 can be within a range of 5 milliamps to 10 milliamps when the first light source maximum current for the light sources of the collimated backlight is between 15 milliamps to 30 milliamps. As described herein, the light source maximum current can correspond to a particular pulse width modulation (PWM) duty cycle and/or a resulted brightness range of the light sources of the collimated backlight 346.

In some examples, utilizing a first electrical connection 320-1 with a first resistance that can allow the driver 316 to provide a first light source maximum current to the light sources of the collimated backlight during a first mode and utilizing a second electrical connection 320-2 with a second resistance or added resistor 322 to provide a second light source maximum current to the light sources 324 during a second mode can allow relatively lower resulted brightness during the second mode compared to previous systems and methods that utilized a single electrical connection.

The system 300 can provide a relatively higher PWM duty cycle and a relatively lower minimum resulted brightness during the second mode by utilizing the second electrical connection 320-2 compared to utilizing the first electrical connection 320-1. For example, the system 300 may be limited to providing a maximum PWM duty cycle of 12 percent when utilizing the first electrical connection 320-1 for a private mode while the system 300 may be capable of providing a maximum PWM duty cycle of 30 percent when utilizing the second electrical connection 320-2 for a private mode. In this way, the system 300 can provide a better image quality and brightness ranges for a private mode compared to systems that utilize the same electrical connection to provide a sharing mode and a private mode.

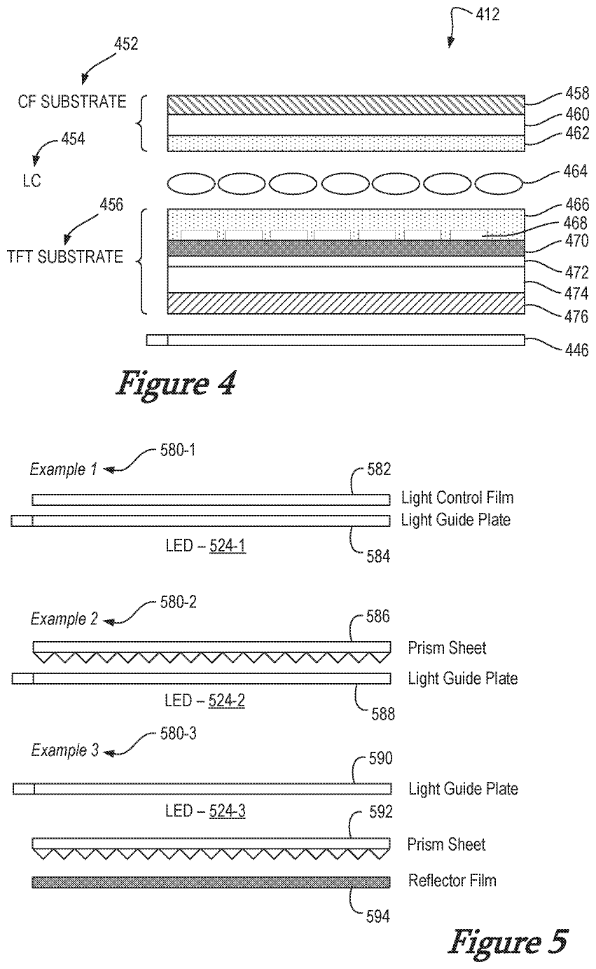

FIG. 4 is an example display 412 for providing display modes consistent with the present disclosure. FIG. 4 illustrates a cross section view of the display 412 to illustrate different layers of the display 412. In some examples, the display 412 can include a collimated backlight 446 that can direct substantially parallel light rays toward the other layers of the display 412 (e.g., in an upward direction as illustrated in FIG. 4, etc.). As described herein, the collimated backlight 446 can include a plurality of LEDs that are collimated to direct the light emitted from the LEDs in a substantially parallel direction.

In some examples, the display 412 can include a thin-film transistor (TFT) substrate layer 456, a liquid crystal (LC) layer 454, and/or a color filter (CF) substrate layer 452. In some examples, the CF substrate layer 452 can include a polarizer 458, a glass substrate 460, and/or an alignment substrate 462. In some examples, the CF substrate layer 452 can have a common electrode removed. That is, the CF substrate layer 452 may not include a common electrode to control a pre-tilt angle of a liquid crystal from the LC layer 454 adjacent to the CF substrate 452. In some examples, the LC layer 454 can include a plurality of liquid crystals 464 that can be aligned to form objects or images on the display 412.

In some examples, the TFT substrate 456 can include an alignment substrate 466 with a plurality of pixel electrodes 468. The TFT substrate 456 can also include an insulator 470, a common electrode 472, a glass substrate 474, and/or a polarizer 476. A plurality of layers are described that form the TFT substrate 456, however, additional layers can be added or fewer layers can be utilized to form the TFT substrate 456. In some examples, the collimated backlight 446 can provide light from a plurality of light sources such as LEDs, such that the light is projected through the TFT substrate 456, through the LC layer 454, and through the CF substrate layer 452. In some examples, a computing device or system can be coupled to the display 412 to project digital images from the computing device or system onto the display 412. As described herein, the computing device can also be utilized to control a connection between the collimated backlight 446 and a driver to alter a mode of the display 412 from a sharing mode to a privacy mode as described herein.

FIG. 5 is an example of different collimated backlights 580-1, 580-2, 580-3 for providing display modes consistent with the present disclosure. As described herein, a collimated backlight, such as collimated backlights 580-1, 580-2, 580-3 can be utilized to direct light emitted from a plurality of light sources such that the light emitted is parallel to other emitted light from other light sources of the plurality of light sources.

In some examples, the collimated backlight 580-1 can include a light control film 582, a light guide plate 584, and a plurality of LEDs 524-1. In some examples, the LEDs 524-1 can be utilized to generate light rays. In some examples, the light rays can be directed in almost all directions, including a horizontal direction to the LEDs 524-1 and/or the light guide plate 584. In some examples, the light guide plate 584 can eliminate or remove light from passing in the horizontal direction by only allowing light rays to pass when the light rays are directed in a vertical direction (e.g., toward the top of FIG. 5) toward the light control film 582. In some examples, the light control film 582 can filter out light at relatively large angles and/or only permit the light of a narrow angle to pass through the light control film 582. As the rays of light from the LEDs 524-1 pass through the light guide plate 584 and through the light control film 582, the light is collimated.

In some examples, the collimated backlight 580-2 can include a prism sheet 586, a light guide plate 588, and a plurality of LEDs 524-2. In some examples, the LEDs 524-2 can be utilized to generate light rays. In some examples, the light rays can be directed in almost all directions, including a horizontal direction to the LEDs 524-2 and/or the light guide plate 588. In some examples, the light guide plate 588 can eliminate or remove light from passing in the horizontal direction by only allowing light rays to pass when the light rays are directed in a vertical direction (e.g., toward the top of FIG. 5) toward the prism sheet 586. In some examples, the prism sheet 586 can filter out light at relatively large angles and/or only permit the light of a narrow angle to pass through the prism sheet 586. As the rays of light from the LEDs 524-2 pass through the light guide plate 588 and through the prism sheet 586, the light is collimated.

In some examples, the collimated backlight 580-3 can include a prism sheet 592, a light guide plate 590, a plurality of LEDs 524-3, and a reflector film 594. In some examples, the LEDs 524-3 can be utilized to generate light rays between the light guide plate 590 and the prism sheet 592. In some examples, the light rays can be directed in almost all directions, including a horizontal direction to the LEDs 524-3. In some examples, the light guide plate 588 can eliminate or remove light from passing in the horizontal direction by only allowing light rays to pass when the light rays are directed in a vertical direction (e.g., toward the top of FIG. 5). In some examples, the prism sheet 592 can filter out light at relatively large angles and/or only permit the light of a narrow angle to pass through the prism sheet 592 toward a reflector film 594. The reflector film 594 can direct the large angle light rays from the prism sheet 592 toward the light guide plate 590, Thus, a first portion of light from the LEDs 524-3 can pass through the light guide plate 590 and a second portion of the light from the LEDs 524-3 can pass through the prism sheet 592 and reflected by the reflector film 594 back through the light guide plate 590. In this way, light from the LEDs 524-3 can be collimated as it passes through the light guide plate 590.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of” an element and/or feature can refer to any number of such elements and/or features.

What is claimed:

1. A device, comprising:
a display that includes a plurality of light sources and a collimated backlight;
a driver coupled to a switch that is coupled to the plurality of light sources with a first electrical connection for a first mode and a second electrical connection for a second mode, wherein the first electrical connection provides a first amperage to the plurality of light sources and the second electrical connection provides a second amperage to the plurality of light sources; and
a computing device comprising instructions executable by a processing resource to:
initiate the first mode by providing an instruction to the switch to activate the first electrical connection; and
initiate the second mode by providing an instruction to the switch to activate the second electrical connection.

2. The device of claim 1, wherein the first amperage includes a maximum amperage of 20 milliamps and the second amperage includes a maximum amperage of 8 milliamps.

3. The device of claim 2, wherein the second electrical connection includes a resistor device to alter the maximum amperage from 20 milliamps to 8 milliamps.

4. The device of claim 1, wherein the first mode includes a brightness that is above a threshold brightness and the second mode includes a brightness that is below the threshold brightness.

5. The device of claim 1, wherein the first mode is adjustable to a brightness level that exceeds 1000 nits and the second mode is adjustable to a brightness level that is below 10 nits.

6. A non-transitory computer-readable storage medium comprising instructions when executed cause a processor of a computing device to:
activate a first connection path between a light emitting diode (LED) driver and a plurality of LEDs of a display during a first mode of the display; and
activate a second connection path between the LED driver and the plurality of LEDs of the display during a second mode of the display, wherein the first connection path includes a first resistance and the second connection path includes a second resistance that is different than the first resistance.

7. The non-transitory computer-readable storage medium of claim 6, wherein the first connection path is activated in response to a first selection and the second connection path is activated in response to a second selection.

8. The non-transitory computer-readable storage medium of claim 6, wherein the second connection path is deactivated when the first connection path is activated and wherein the first connection path is deactivated when the second connection path is activated.

9. The non-transitory computer-readable storage medium of claim 6, wherein the first connection path is activated in response to a selection of a brightness level that exceeds a brightness level threshold and wherein the second connection path is activated in response to a selection of a brightness level that is below the brightness level threshold.

10. A system comprising:
a display that includes:
a collimated backlight comprising a plurality of light sources;
a light source driver coupled to a switch; and
the switch coupled to a first connection path to the plurality of light sources and a second connection path coupled to the plurality of light sources; and
a computing device comprising instructions executable by a processing resource to:
initiate a first mode of the display by providing an instruction to the switch to activate the first connection path and deactivate the second connection path; and
initiate the second mode by providing an instruction to the switch to activate the second connection path and deactivate the first connection path.

11. The system of claim 10, wherein the first connection path provides a first pulse width modulation (PWM) duty cycle range and the second connection path provides a second PWM duty cycle range that is different than the first PWM duty cycle.

12. The system of claim 10, wherein the first connection path provides a first brightness for the plurality of light sources above a threshold brightness level and the second connection path provides a second brightness for the plurality of light sources below the threshold brightness level.

13. The system of claim 10, wherein the second brightness for the plurality of light sources is adjustable below 10 nits.

14. The system of claim 10, wherein the collimated backlight is coupled to a light control film.

15. The system of claim 10, wherein the display includes a color filter (CF) substrate without a common electrode to the plurality of light sources.
